(19) United States
(12) Patent Application Publication
(10) Pub. No.: US 2009/0181842 A1
(43) Pub. Date: Jul. 16, 2009

(54) POLARIZATION-MAINTAINING OPTICAL FIBER AND METHOD FOR MANUFACTURING THE SAME

(75) Inventors: Antoine Proulx, Quebec (CA); Steeve Morency, Sainte-Etienne (CA); Claude Pare, Saint-Augustin De Desmaures (CA)

Correspondence Address: MERCHANT & GOULD, P.C., 3200 IDS Center, 80 South Eighth Street, Minneapolis, MN, 55402-2215, US

(73) Assignee: INSTITUT NATIONAL D'OPTIQUE, Quebec (CA)

(21) Appl. No.: 12/350,571

(22) Filed: Jan. 8, 2009

Related U.S. Application Data
(60) Provisional application No. 61/019,698, filed on Jan. 8, 2008.

(51) Int. Cl. C03C 13/04; C03B 37/028

(52) U.S. Cl. 501/37; 65/412

(57) ABSTRACT

A method for manufacturing a polarization-maintaining optical fiber is provided. The method includes (a) making a fiber preform by providing in an over-cladding tube: a core rod having an inner core and a cladding surrounding the inner core; at least one stress-applying part (SAP) disposed adjacent to the core rod along an outer periphery of the cladding thereof and having a coefficient of thermal expansion different from that of the cladding; inner filler rods arranged along the outer periphery of the core rod at positions where the SAP is not disposed and having a coefficient of thermal expansion different from that of the SAP; and a plurality of outer filler rods arranged adjacent the over-cladding tube between the over-cladding tube and inner filler rods, SAP and core rod, and consisting of a same material as the over-cladding tube; and (b) drawing the fiber preform to obtain the optical fiber.

This application claims benefit of Ser. No. 61/019,698, filed Jan. 8, 2008 in the United States and which application is incorporated herein by reference. To the extent appropriate, a claim of priority is made to the above disclosed application.

### FIELD OF THE INVENTION

The invention relates to a polarization-maintaining optical fiber and a method for manufacturing the same. More particularly, it relates to a polarization-maintaining optical fiber having a large doped inner-region suitable for high power fiber lasers and amplifiers.

### BACKGROUND OF THE INVENTION

Optical fibers are used in a variety of applications such as telecommunications, illumination, fiber lasers, laser machining and welding, sensors, medical diagnostics and surgery.

A typical standard optical fiber is made of transparent material. It is uniform along its length, and has a cross-section of varying refractive index. For example, the transparent material in the central region, i.e. the core, may have a higher refractive index than the transparent material in the outer region, i.e. the cladding. Light is confined in or near the core and guided along the length of the optical fiber by the principle of total internal reflection at the interface between the core and cladding.

In general, an optical fiber may be multi-mode or single-mode. A multi-mode fiber allows for more than one mode of the light wave, each mode travelling at a different phase velocity, to be confined to the core and guided along the fiber. A single-mode fiber supports only one transverse spatial mode at a frequency of interest. Given a sufficiently small core or a sufficiently small numerical aperture (defined as NA=\sqrt{n_{core}²−n_{cladding}²}, where n_{core} and n_{cladding} represent the refractive index of the core and the cladding, respectively) it is possible to confine a single mode, the fundamental mode, to the core. Single-mode fibers are preferred for many applications because the problem of intermodal dispersion encountered by multi-mode fibers is avoided, and the intensity distribution of the light wave emerging from the fiber is unchanged regardless of launch conditions and any disturbances of the fiber.

For some applications, it is advantageous to carry as much optical power as possible. However, if the light intensity within the fiber exceeds a certain threshold, the material from which the fiber is made will suffer irreversible damage. Increasing the diameter size of the core of the fiber reduces the intensity of the light for a given power and allows a greater power to be carried without damage. Using a larger core fiber also helps to reduce the non-linear effects that appear at high power. For example, in the field of high-power lasers and amplifiers, the onset of adverse non-linear effects can severely degrade the spectral content and limit the power output of the laser source. Using a single-mode large-mode-area active fiber as the amplifying medium is a relatively easy solution to the problem of non-linear effects which can be detrimental to the operation of the laser.

For applications in high-power lasers and amplifiers, it is therefore desirable to use an active multi-clad polarization-maintaining (PM) optical fiber having a large doped inner-region. This doped inner region of the fiber has a central core region surrounded by a cladding region. The central core may be composed of silica-based material containing a certain concentration of an active ion (e.g.: ytterbium, neodymium, . . . ), along with an appropriate concentration of one or more of the usual co-dopants typically found in active optical fibers, such as aluminum, germanium, phosphorous, boron, fluorine, etc. This central core is surrounded by a first cladding composed of doped-silica having a refractive index lower than that of the central core but higher than that of an outer second cladding made of pure silica. For example, this first cladding may be composed of germanium-doped silica. In the situation where this inner cladding is surrounded by a second cladding of lower refractive index (e.g.: pure silica), which is also surrounded by an even lower refractive index polymer, the result is a “triple-clad optical fiber” [Reference: U.S. Pat. No. 6,941,053 (Lauzon et al)]. One or more supplemental claddings may be added between any two of the above-mentioned claddings to generally form a “multi-clad optical fiber” [reference: U.S. Pat. No. 7,068,900 (Croteau et al)].

The purpose of the raised-index first cladding is to allow for high pump power to be injected into a larger numerical aperture while providing a highly doped core having a numerical aperture small enough to have single-mode or quasi-single-mode operation. Some benefits attributable to the ability to dope the central core with a significant concentration of certain specific dopants include:
High rare-earth ions concentration: This allows for high pump absorption per unit length, which in turn allows the use of relatively short sections of rare-earth-doped fibers. Being able to use short fiber sections is crucial in high-power fiber lasers and amplifiers because it limits adverse nonlinear effects such as Stimulated Brillouin Scattering (SBS). More so, in the case of a PM fiber, using a short fiber section leads to a higher polarization extinction ratio (PER), which may be of critical importance for some applications.
High co-dopants concentration: In some cases, the presence of specific co-dopants can be necessary in order to have optimal fiber properties. For example, Yb-doped fibers need to be co-doped with a sufficient concentration of aluminum in order to avoid clustering and to efficiently convert the pump power into signal power in a laser or an amplifier. Furthermore, introducing a sufficiently high aluminum and/or phosphorus concentration in an Yb-doped core can significantly reduce the adverse effects of photodarkening, which is a fiber degradation phenomenon that can severely degrade the performances of fiber lasers and amplifiers.

A design parameter to consider is the thickness of the raised-index first cladding. In the case of a fiber having a thin first cladding, the fiber can be very resistant to bend losses, which is useful for a purely single-mode fiber, but can prohibit higher-order mode filtering through fiber bending. For very high-power application, which commands a large core, it can become difficult to fabricate an optical fiber having a core numerical aperture sufficiently small to ensure a purely single-mode operation of the fiber. For those cases, a large-dimensioned first cladding can permit higher-order mode filtering through bend losses and effective single-mode operation of the fiber. A large first cladding allows the use of the differential bending losses to achieve enhanced mode quality in terms of M², astigmatism and modal roundness in a triple-clad/multi-clad large-mode-area fiber design.

A principal difficulty associated with a large first-cladding multi-clad fiber design in which the first cladding is composed of doped silica is the fabrication of a polarization-maintaining version of such a fiber. Typically, the fabrication of a polarization-maintaining optical fiber involves drilling a hole on each side of the core in the mother preform for insertion of two stress-applying parts (SAP) and then drawing the preform into a polarization-maintaining (PM) fiber. The most common implementations of such PM fibers are the Panda double-clad or triple-clad fibers, where the SAPs are inserted into a second cladding consisting of pure silica. FIG. 1A is a schematic representation of such a PM triple-clad optical fiber, showing a thin first cladding consisting preferably of doped silica. The drilling operation of Panda fibers is generally well mastered and such fibers have been commercially available for several years. However, the fabrication becomes much more complicated for multi-clad fiber designs in which the doped-silica region extends away from the core. For those preform designs, it would be necessary to drill the doped-silica region so that the SAPs are positioned close enough to the central core to ensure a sufficient amount of stress-induced birefringence.

Typically, such a drilling operation is extremely difficult and in some cases almost impossible, especially in the case where the concentration of dopants in the cladding region to be drilled is substantial. FIG. 1B is a schematic representation of such a PM triple-clad optical fiber having a thick first cladding consisting preferably of doped silica and a second cladding consisting of pure silica. (The third cladding, not shown in either FIG. 1A or FIG. 1B, may typically consist of a low-index polymer or a fluorine-doped silica layer.)

### SUMMARY OF THE INVENTION

In accordance with a first aspect of the present invention, there is provided a method for manufacturing a polarization-maintaining optical fiber, the method including:
(a) making a fiber preform by providing in an over-cladding tube:
   (i) a core rod including an inner core and a cladding surrounding the inner core, the cladding including at least one cladding layer surrounding the inner core;
   (ii) at least one stress-applying part disposed adjacent to the core rod along an outer periphery of the cladding thereof, the stress-applying part including material having a coefficient of thermal expansion different from a coefficient of thermal expansion of the cladding of the core rod;
   (iii) a plurality of inner filler rods arranged adjacent to the core rod along the outer periphery of the cladding at positions where the at least one stress-applying part is not disposed, the inner filler rods comprising material having a coefficient of thermal expansion different from that of the at least one stress-applying part; and
   (iv) a plurality of outer filler rods arranged adjacent the over-cladding tube between the over-cladding tube and the inner filler rods, the at least one stress-applying part and the core rod, the outer filler rods consisting of a same material as the over-cladding tube; and
(b) drawing the fiber preform to obtain the optical fiber.

At least one of the inner filler rods may have a different diameter.

The plurality of inner filler rods may include primary inner filler rods that have a diameter substantially equal to a diameter of the at least one stress-applying part, and secondary inner filler rods that have a diameter smaller than a diameter of the primary inner filler rods and are arranged in gaps between the core rod, the at least one stress-applying part and the primary inner filler rods.

The plurality of outer filler rods may have substantially a same refractive index as the over-cladding tube and/or substantially a same coefficient of thermal expansion as the cladding of the core rod.

In accordance with a second aspect of the present invention, there is provided a method for manufacturing a polarization-maintaining optical fiber, the method including:
(a) making a fiber preform by providing in an over-cladding tube:
   (i) a core rod including an inner core and a cladding surrounding the inner core, the cladding comprising at least one cladding layer surrounding the inner core;
   (ii) at least one stress-applying part disposed adjacent to the core rod along an outer periphery of the cladding thereof, the stress-applying part including a material having a coefficient of thermal expansion different from a coefficient of thermal expansion of the cladding of the core rod;
   (iii) a plurality of inner filler rods arranged adjacent to the core rod along the outer periphery of the cladding at positions where the at least one stress-applying part is not disposed, the inner filler rods including a plurality of primary inner filler rods and a plurality of secondary inner filler rods wherein the secondary inner filler rods have a diameter smaller than a diameter of the primary inner filler rods and are arranged in gaps between the core rod, the at least one stress-applying part and the primary inner filler rods, the inner filler rods including material having a coefficient of thermal expansion different from that of the at least one stress-applying part; and
(b) drawing the fiber preform to obtain the optical fiber.

The cladding of the core rod may include two or more cladding layers surrounding the inner core.

The primary inner filler rods may have a diameter substantially equal to a diameter of the at least one stress-applying part. In general, the primary inner filler rods may have different diameters for space-filling arrangement about the core rod.

The primary inner filler rods may have substantially a same refractive index as the secondary inner filler rods. Additionally or alternatively, they may have substantially a same coefficient of thermal expansion as the secondary inner filler rods.

The plurality of inner filler rods may have substantially a same coefficient of thermal expansion as the cladding of the core rod.

The step of making a fiber preform may include providing in the over-cladding tube a plurality of outer filler rods arranged adjacent the over-cladding tube between the over-cladding tube and the inner filler rods, the at least one stress-applying part and the core rod, the outer filler rods consisting of a same material as the over-cladding tube.

In accordance with a third aspect of the present invention, a polarization-maintaining optical fiber obtained according to the method(s) described above is provided.

In accordance with a fourth aspect of the present invention, use of the polarization-maintaining optical fiber, obtained according to the method(s) described above, in a fiber amplifier or fiber laser is provided.

In accordance with a fifth aspect of the present invention, there is provided a fiber preform for making a polarization-maintaining optical fiber which includes:
an over-cladding tube;
a core rod including an inner core and a cladding surrounding the inner core, the cladding including at least one cladding layer surrounding the inner core;
at least one stress-applying part disposed adjacent to the core rod along an outer periphery of said cladding thereof, the stress-applying part including material having a coefficient of thermal expansion different from a coefficient of thermal expansion of the cladding of the core rod;
a plurality of inner filler rods arranged adjacent to the core rod along the outer periphery of the cladding at positions where the at least one stress-applying part is not disposed, the inner filler rods including material having a coefficient of thermal expansion different from that of the at least one stress-applying part; and
   wherein the core rod, the stress-applying part and the inner filler rods are thus arranged within the over-cladding tube.

The fiber preform may include a plurality of outer filler rods arranged within the over-cladding tube, adjacent the over-cladding tube, between the over-cladding tube and the inner filler rods, the at least one stress-applying part and the core rod, the outer filler rods consisting of a same material as the over-cladding tube.

At least one of the inner filler rods may have a different diameter. The plurality of inner filler rods may include a plurality of primary inner filler rods and a plurality of secondary inner filler rods, the secondary inner filler rods having a diameter smaller than a diameter of the primary inner filler rods and being arranged in gaps between the core rod, the at least one stress-applying part and the primary inner filler rods.

The objects, advantages and other features of the present invention will become more apparent and be better understood upon reading of the following non-restrictive description of the preferred embodiments of the invention, given with reference to the accompanying drawings. The accompanying drawings are given purely for illustrative purposes and should not in any way be interpreted as limiting the scope of the invention.

### BRIEF DESCRIPTION OF THE DRAWINGS

FIG. 1A (PRIOR ART) is a schematic representation of a prior art PM triple-clad optical fiber, showing a thin first cladding; FIG. 1B (PRIOR ART) is a schematic representation of a prior art PM triple-clad optical fiber, showing a thick first cladding.

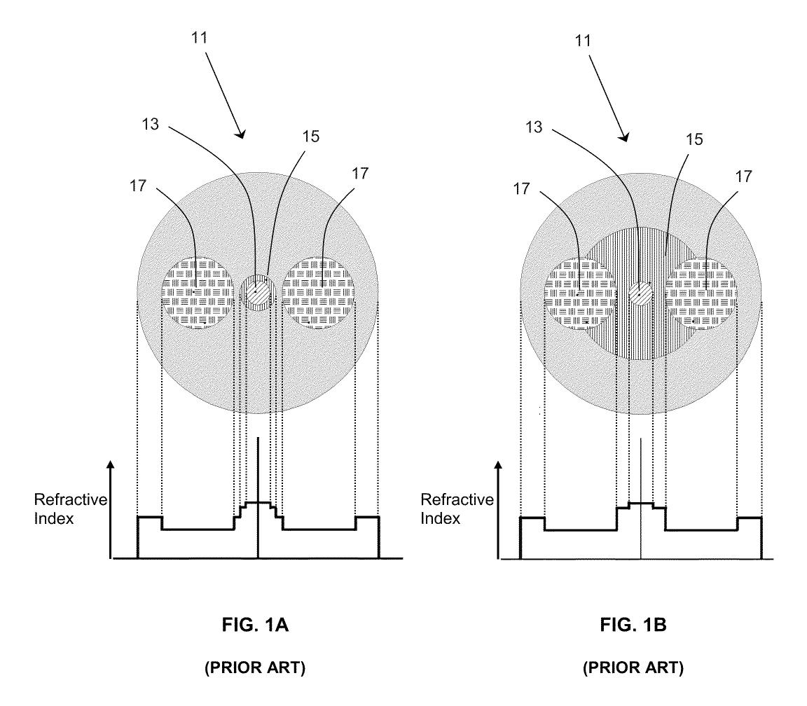

FIG. 2 is a schematic representation of a cross-section of a fiber preform in accordance with an embodiment of the present invention.

FIG. 3 is a schematic representation of a cross-section of a fiber preform in accordance with another embodiment of the present invention.

FIG. 4 is a schematic representation of a cross-section of a fiber preform in accordance with yet another embodiment of the present invention.

FIG. 5A is a schematic representation of a polarization-maintaining fiber obtained using the fiber preform of FIG. 4; FIG. 5B is an optical micrograph of a polarization-maintaining fiber obtained in accordance with an embodiment of the present invention.

FIG. 6 is a schematic representation of a cross-section of a fiber preform in accordance with yet another embodiment of the present invention, showing inner filler rods of varying diameters.

FIG. 7 is a flow chart generally illustrating a method for manufacturing a polarization-maintaining optical fiber according to an aspect of the present invention.

### DESCRIPTION OF THE INVENTION

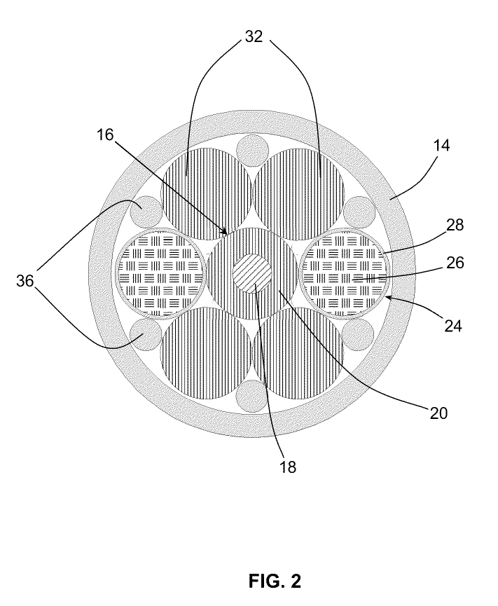

The aspects of the present invention will be described more fully hereinafter with reference to FIGS. 2 to 7 wherein like numerals refer to like elements throughout.

The polarization of light travelling in a standard optical fiber changes in an uncontrolled, wavelength-dependent manner because optical fibers generally exhibit some degree of birefringence owing to mechanical stress, for example mechanical stress arising from any bending of the fiber or changes in temperature of the fiber. However, fluctuations or uncontrolled changes in the polarization state of light are highly detrimental in many high-power applications. For applications where the polarization state cannot be allowed to drift, polarization-maintaining (PM) fibers having a strong built-in birefringence that favourably preserves a given polarization state are preferably used. As mentioned previously, large-mode-area (LMA) double-clad fibers are typically used for high-power pulsed-laser applications. As such, the large diameter of the active core-cladding region must be taken into account when introducing a controlled stress-induced birefringence by incorporating one or more stress-applying parts (SAPs).

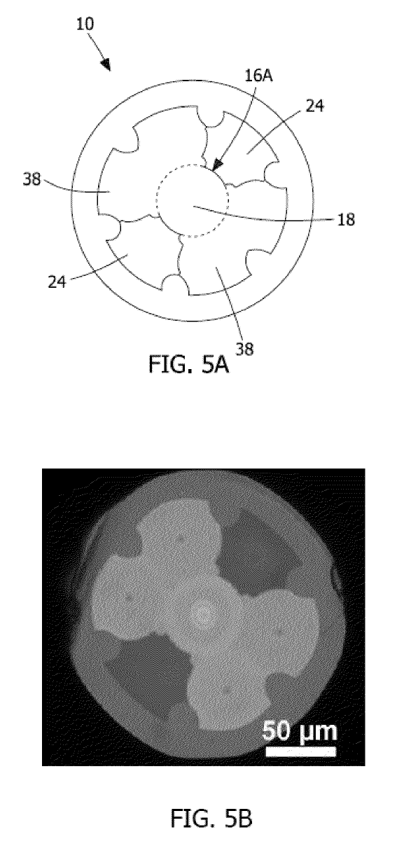

The present invention aims to provide a polarization-maintaining optical fiber 10 (for example, a PM fiber as shown in FIGS. 5A and 5B) that has an active core-cladding region in which the cladding region 38 extends away from the core region 16A farther than the inner edges of the SAPs 24 used to manufacture the PM fiber, and that has a refractive index lower than the inner core 18 so as to provide the large actively-doped core-cladding region necessary for high power applications. In the case of an active large-mode-area PM fiber with a thick cladding, mode filtering can be carried out through bend losses in order to be able to achieve excellent mode quality in terms of M² (M-Squared), mode circularity and astigmatism. The M-squared, astigmatism and beam roundness, which are critical parameters characterizing the quality of a laser beam at the output of a LMA optical fiber, can all be negatively affected by an increase of the fraction of the total energy propagating in the higher-order modes.

Small mode-area single-mode fibers need not have a multi-clad design as they can be designed to be intrinsically single-moded even if they have a large numerical aperture.

As it has been mentioned above, a PM large-mode-area multi-clad fiber suitable for high power applications can be extremely difficult to fabricate through the conventional drilling procedure due to the risk of cracking the preform while drilling in the doped cladding region.

Hence, in accordance with aspects of the present invention, there is provided a method for manufacturing a polarization-maintaining optical fiber—one that avoids such a drilling process—and a polarization-maintaining optical fiber obtained therefrom, as described in more detail hereinbelow.

### PM Optical Fiber and Method of Manufacturing the Same

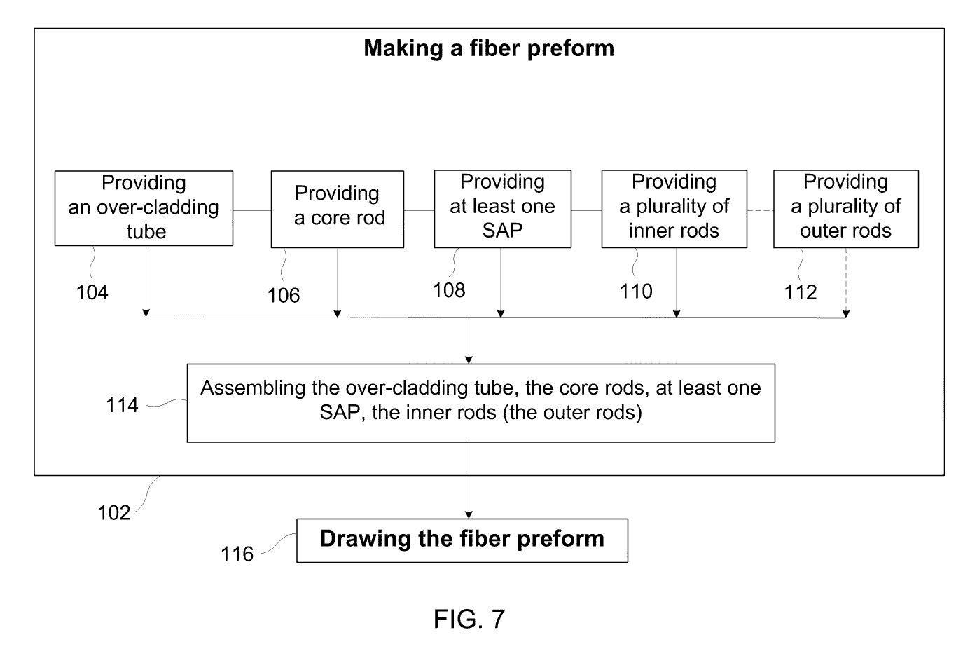

In general, as depicted in FIG. 7, the present invention is directed to a method for manufacturing a polarization-maintaining optical fiber 10 that includes: (a) making a fiber preform 12, and (b) drawing the fiber preform 12 to obtain the PM fiber 10. The method will be described hereinbelow with reference to the drawings and particularly FIG. 7 which shows a flow chart depicting the method in general.

### (a) Making the Fiber Preform

As shown in FIG. 7, in order to manufacture a PM fiber 10 with stress-induced birefringence, a fiber preform 12 is assembled from several separate elements, each constituent element having a specific composition such that the resulting drawn PM fiber will have a refractive index profile corresponding to the particular layout of the preform assembly.

To start, an over-cladding tube 14 in which the separate elements of the fiber preform 12 may be assembled is provided (104). The over-cladding tube 14 may be made of silica glass, preferably pure undoped silica glass, but of course it may be made of any appropriate material.

The fiber preform 12 is made (102) by generally providing in the over-cladding tube 14 the following elements: a core rod, at least one stress-applying part (SAP), inner filler rods and/or outer filler rods (106, 108, 110 and/or 112 respectively depicted in FIG. 7). In general, the elements of the fiber preform are assembled and inserted into the over-cladding tube (114). The elements may be assembled and the assembled elements then inserted as a whole into the over-cladding tube. For certain embodiments, it may be preferable to first assemble and insert the bulk of the elements into the over-cladding tube and then insert smaller elements into the over-cladding tube. Of course, for certain geometries it may be preferable to insert each element one at a time into the over-cladding tube. As such, it should be understood that the elements may be assembled and inserted into the over-cladding tube as required.

### Core Rod

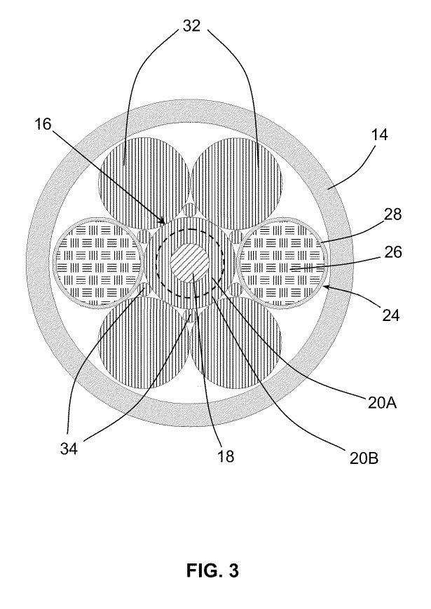

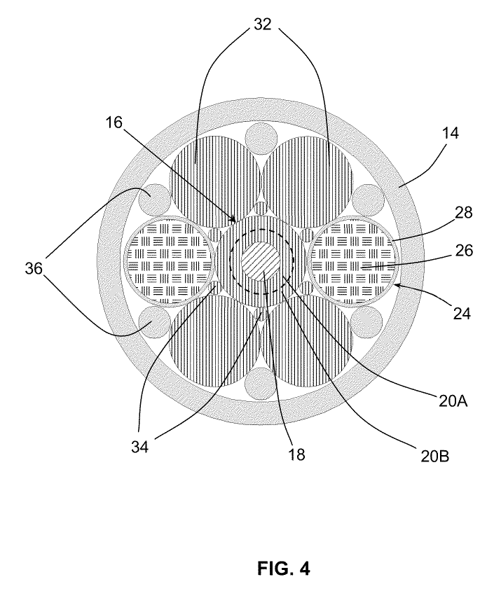

As shown in the exemplary fiber preforms 12 of FIGS. 2 to 4 and 6, a core rod 16 is provided (106) and arranged (114) within the over-cladding tube 14. The core rod 16 has an inner core 18 and a cladding 20 surrounding the inner core 18. The cladding 20 includes at least one cladding layer surrounding the inner core 18, but may include more than one cladding layer, depending on the desired refractive index profile of the resulting drawn PM fiber 10. In the exemplary fiber preforms of FIGS. 3 and 4, the core rods 16 depicted have two cladding layers, an inner cladding layer 20A surrounding the inner core 18 and an outer cladding layer 20B surrounding the inner cladding layer 20A.

Advantageously for an active PM optical fiber, the inner core 18 and the cladding 20 may be composed of doped silica glass, for example silica-based material containing a certain concentration of an active ion (e.g. ytterbium, neodymium, etc.) along with an appropriate concentration of one or more co-dopants typically found in active optical fibers (e.g. aluminum, germanium, phosphorous, boron, fluorine, etc.). In order to optimize the size of the doped core region of the resulting PM fiber, as is needed for high power applications, the cladding 20—or in the case of a multi-layer cladding at least the innermost cladding layer 20A—may have a refractive index lower than that of the inner core 18. However, as mentioned above, the cladding may have any appropriate refractive index profile, for example a depressed cladding profile, a pedestal cladding profile, etc.

### Stress-Applying Part (SAP)

At least one stress-applying part (SAP) 24 is provided (108) and disposed adjacent to the core rod 16 along an outer periphery of the cladding 20 thereof. The stress-applying part 24 includes material having a coefficient of thermal expansion that is different from that of the cladding 20 of the core rod 16. Due to the difference in coefficients of thermal expansion, a mechanical stress is applied to the inner core-cladding region 16A of the PM fiber 10 shown in FIGS. 5A and 5B upon cooling of the PM fiber 10 drawn from the fiber preform 12 resulting in changes in the refractive index of the inner core-cladding region 16A along the direction of the mechanical stress and hence in the desired stress-induced birefringence.

Since the SAP 24 is disposed adjacent to the core rod 16 along an outer periphery of the cladding 20 of the core rod 16, the refractive index of the SAP 24 may be lower than, substantially the same as or as close as possible to the refractive index of the cladding 20, or at least the outer cladding layer 20B in the case of a multi-layer cladding. It is actually advantageous to have SAPs with a refractive index lower than that of the cladding to help mode mixing and also to enhance the power density in the cladding, which may be preferable for short fibers. SAPs may have a refractive index substantially the same as that of an outer layer of the cladding so as to prevent diffusion of light that is travelling through the cladding 20 to the SAP 24. Of course, the SAP(s) may have a refractive index slightly higher than that of the cladding without causing any detrimental effects to the operation of the resultant PM fiber.

As seen in the exemplary fiber preforms of FIGS. 2 to 4 and 6, the SAP 24 may include a doped silica core 26 and a cladding layer 28 surrounding the doped silica core 26. The cladding layer poses no optical problem for the SAP which typically has a lower refractive index than the cladding of the core rod and hence the cladding of the resultant PM fiber.

The doped silica core 26 of the SAP 24 may contain germanium oxide, boron oxide, fluorine, phosphorous oxide, lead oxide, aluminum oxide, zirconium oxide, or any combination thereof so as to exhibit a coefficient of thermal expansion that is greater than that of pure silica glass. Titanium oxide may be used to decrease the coefficient of thermal expansion. Now, among the above-mentioned compounds, germanium oxide, phosphorous oxide, titanium oxide, lead oxide, aluminum oxide, and zirconium oxide may be introduced into silica glass to increase the refractive index of silica glass while boron oxide and fluorine may be introduced into silica glass to reduce the refractive index of silica glass.

One or more SAPs 24 may be used to create the stress-induced birefringence in the resultant PM fiber 10. The SAPs 24 may be disposed at discrete intervals along the outer periphery of the cladding 20 of the core rod 16. In one embodiment, two SAPs 24 may be diametrically opposed along the outer periphery of the cladding 20. In another embodiment, two or more SAPs may be disposed symmetrically, with respect to an axis of the core rod 16, along the outer periphery of the core rod 16. It should be noted that although two diametrically opposed SAPs are depicted in the exemplary fiber preforms of FIGS. 2 to 4 and 6, this should by no means be construed as a limitation on or preference for the number and location of SAPs used to obtain the PM fiber.

### Inner Filler Rods

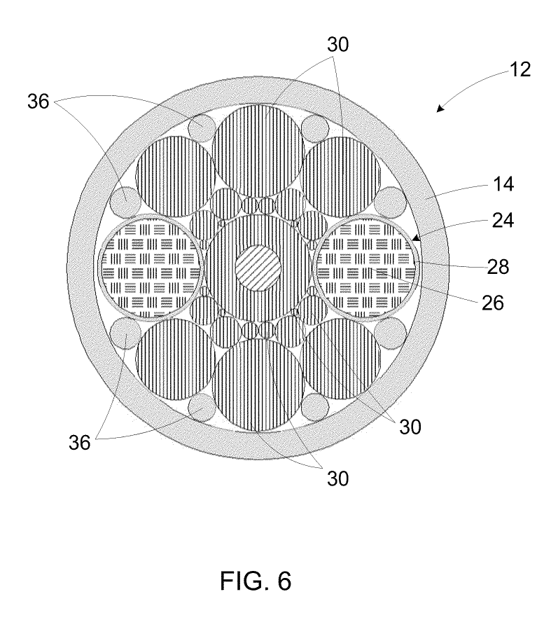

In order to create a thick doped cladding region 38 of the PM fiber 10 as shown in FIGS. 5A and 5B, a plurality of inner filler rods are provided (110) and arranged adjacent to the core rod 16 along the outer periphery of its cladding 20 at positions where the stress-applying part(s) 24 is (are) not disposed, as shown in FIGS. 2 to 4 and 6. The inner filler rods are used to extend the cladding, especially past the edge of the SAP(s) 24—in this way, a PM fiber can be obtained without the manufacturing risks associated with drilling—and any arrangement that fills the space between the core rod 16, the SAP(s) 24 and the over-cladding tube 14. The inner filler rods may be of the same diameter or of different diameters. At least one of the inner filler rods may have a diameter different from the other inner filler rods. In accordance with the embodiment shown in FIG. 6, inner filler rods 30 of various diameters may be used to optimally fill the space between the core rod 16, the SAP(s) 24 and the over-cladding tube 14 and to ensure a circular core for the resultant PM fiber. In accordance with another embodiment, the inner filler rods may include primary inner filler rods 32 (seen in FIGS. 2 to 4) as well as secondary filler rods 34 (seen in FIGS. 3 and 4). Here, the primary inner filler rods 32 are larger than the secondary inner filler rods 34, preferably having a diameter substantially equal to a diameter of the SAP 24, and are used to create the bulk of the cladding 38 of the PM fiber 10 shown in FIGS. 5A and 5B. The secondary inner filler rods 34 advantageously have a diameter smaller than a diameter of said primary inner filler rods so that they may be arranged in the gaps found between the core rod 16 and the SAP(s) and in the gaps found between the core rod 16 and the said primary inner filler rods 32. These secondary inner filler rods are used to ensure that the core of the resultant PM fiber remains circular as opposed to slightly hexagonal in the absence of these inner filler rods. As such, the primary inner filler rods 32 and the secondary inner filler rods 34 ideally would consist of the same material and have the same coefficient of thermal expansion and the same index of refraction.

The inner filler rods are made of a material having a coefficient of thermal expansion different from that of the stress-applying part (SAP) 24, but preferably similar to that of the cladding 20 and inner core 18 of the core rod 16 so as not to negate the stress-induced birefringence created by the SAP 24.

The inner filler rods may have a refractive index the same as, higher than or lower than the cladding 20. Not all of the inner filler rods need have the same refractive index. Generally, the inner filler rods have a refractive index consistent with the desired refractive index profile of the core-cladding region and the optical properties of the resultant PM fiber.

### Outer Filler Rods

In accordance with an aspect of the present invention, a plurality of outer filler rods 36 consisting of a same material as the over-cladding tube 14 may be provided (112) and arranged adjacent the over-cladding tube 14, between the over-cladding tube 14 and the inner filler rods, the SAP 24 and the core rod 16, to enhance mode-mixing. The role of the outer filler rods 36 is to break the circular symmetry of the fiber to ensure a good energy transfer from the helicoidal modes (propagating in the cladding) exhibiting no overlap with the fiber core to the modes that do cross the core. That way, the absorption of pump light propagating in the cladding by the central active core is enhanced. For a perfectly circularly symmetric fiber, the power contained in the helicoidal modes would not be absorbed by the core of the fiber and would not be available for amplification. The outer filler rods 36 can be seen in FIGS. 2 and 4.

The outer filler rods 36 preferably have substantially a same refractive index as the over-cladding tube 14 and substantially a same coefficient of thermal expansion as the over-cladding tube 14.

For the exemplary fiber preform 12 shown in FIG. 4, a core rod 16 of diameter D₁ is surrounded by four primary inner filler rods 32 and two SAPs 24 of diameter D₁. In order to help fill the gaps between the core rod 16 and the primary inner filler rods 32 and SAPs 24, six secondary inner filler rods 34 of diameter D₂˜D₁/7 are also added to the assembly. Finally, six outer filler rods 36 of diameter D₃˜D₁/3 and made of pure silica are inserted between this assembly and an over-cladding tube 14 made of pure silica outer tube in order to fill the gaps present. It should be noted that the choice of the material for these outer filling rods (i.e. pure silica) is functional as it serves to help the mode mixing in the pump-guide.

### (b) Drawing the Fiber Preform

With the elements of the fiber preform 12 thus assembled, the fiber preform is drawn (116) into an elongated fiber, using for example a fiber drawing tower, thus obtaining the PM optical fiber. As seen from the exemplary PM fiber found in FIGS. 5A and 5B, the PM fiber obtained from this method has a thick cladding region 38 and two SAPs 24 for applying stress on the core region 16A and thereby inducing birefringence.

Therefore, in accordance with an aspect of the present invention, there is provided a PM fiber obtained from the above-described method, for use in a fiber amplifier or fiber laser, more preferably a high power fiber amplifier or fiber laser with mode-filtering possibilities as explained previously hereinabove.

### Fiber Preform

In accordance with yet another aspect of the present invention, there is also provided the fiber preform described hereinabove and shown in FIGS. 2 to 4 and 6 for making a polarization-maintaining optical fiber.

Summarily, the fiber preform 12 includes:
an over-cladding tube 14;
a core rod 16 which includes an inner core 18 and a cladding 20 surrounding the inner core 18, the cladding 20 having at least one cladding layer surrounding the inner core;
at least one stress-applying part 24 disposed adjacent to the core rod 16 along an outer periphery of the cladding 20 thereof, the stress-applying part 24 including material having a coefficient of thermal expansion different from a coefficient of thermal expansion of the cladding 20 of the core rod 16;
a plurality of inner filler rods arranged adjacent to the core rod 16 along the outer periphery of the cladding 20 at positions where the stress-applying part 24 is not disposed, the inner filler rods including material having a coefficient of thermal expansion different from that of the stress-applying part 24; and
   wherein the core rod 16, the stress-applying part 24 and the inner filler rods are thus arranged within the over-cladding tube 14.

The fiber preform may include several outer filler rods 36 arranged within the over-cladding tube 14, adjacent the over-cladding tube 14, between the over-cladding tube 14 and the inner filler rods, the stress-applying part 24 and the core rod 16, the outer filler rods 36 consisting of a same material as the over-cladding tube 14.

The inner filler rods 30 may have various diameters as seen in FIG. 6. They may include a number of primary inner filler rods 32 and a number of secondary inner filler rods 34, the secondary inner filler rods 34 having a diameter smaller than a diameter of the primary inner filler rods 32 and being arranged in gaps between the core rod, the stress-applying part 24 and the primary inner filler rods 32 as seen in FIGS. 2 to 4.

In one particular implementation of the design of the PM fiber 10, the following different elemental-preform types may be needed to fabricate the fiber preform 14:
a core rod preform;
inner filler rod preform(s), which may include several inner filler rod preforms of varying dimensions including (but not limited to) for example a primary inner filler rod preform and a secondary inner filler rod preform;
an outer filler rod preform; and
a SAP preform.

To realize the fiber preform assembly, it may be necessary to draw or stretch the above-mentioned elemental preforms in order to obtain canes of suitable dimension to be used in the assembly. Then, those canes are preferably chemically etched in order to remove the unwanted outer region composed, for example, of pure silica. In order to make the large thick cladding region of the PM optical fiber, it is important to etch the canes to remove the unwanted outer layer of pure silica and obtain the wanted inner doped region. However, it may be desirable to leave a thin layer 28 (e.g. made of pure silica) outside the doped core 26 of the SAP 24. For example, in the case of a boron-doped core of the SAP, the thin cladding layer 28 serves to prevent contact of the boron-doped core with the acid used in the etching process because boron reacts strongly with the acid. The presence of the thin cladding layer poses no optical problem for the SAP which preferably has a refractive index lower than that of the cladding of the core rod and hence the cladding of the resultant PM fiber.

In view of the above description, the present invention is also directed to the polarization-maintaining optical fiber obtained according to the method of the present invention. The polarization-maintaining optical fiber, obtained according to the method of the present invention, may be advantageously used in a fiber amplifier, fiber laser or in any other appropriate optical device.

Numerous modifications could be made to any of the embodiments described above without departing from the scope of the present invention as defined in the appended claims.

1. A method for manufacturing a polarization-maintaining optical fiber, said method comprising:
(a) making a fiber preform by providing in an over-cladding tube:
(i) a core rod comprising an inner core and a cladding surrounding said inner core, said cladding comprising at least one cladding layer surrounding said inner core;
(ii) at least one stress-applying part disposed adjacent to said core rod along an outer periphery of said cladding thereof, said stress-applying part comprising material having a coefficient of thermal expansion different from a coefficient of thermal expansion of said cladding of said core rod;
(iii) a plurality of inner filler rods arranged adjacent to said core rod along said outer periphery of said cladding at positions where said at least one stress-applying part is not disposed, said inner filler rods comprising material having a coefficient of thermal expansion different from that of said at least one stress-applying part; and
(iv) a plurality of outer filler rods arranged adjacent said over-cladding tube between said over-cladding tube and said inner filler rods, said at least one stress-applying part and said core rod, said outer filler rods consisting of a same material as said over-cladding tube; and
(b) drawing said fiber preform to obtain said optical fiber.

2. The method according to claim 1, wherein the overcladding tube is made of silica glass.

3. The method according to claim 1, wherein said inner core comprises doped silica glass.

4. The method according to claim 1, wherein said at least one cladding layer comprises doped silica glass.

5. The method according to claim 1, wherein said at least one cladding layer has a refractive index lower than a refractive index of said inner core.

6. The method according to claim 1, wherein said cladding comprises two or more cladding layers surrounding said inner core.

7. The method according to claim 1, wherein each of said at least one stress applying part is disposed at discrete intervals along the outer periphery of said cladding of said core rod.

8. The method according to claim 1, wherein two or more of said at least one stress applying part are disposed symmetrically, with respect to an axis of said core rod, along the outer periphery of said cladding of said core rod.

9. The method according to claim 1, wherein two of said at least one stress applying part are diametrically opposed along the outer periphery of said cladding of said core rod.

10. The method according to claim 1, wherein said at least one stress applying part comprises a doped core and a cladding layer surrounding said doped core.

11. The method according to claim 1, wherein at least one of said inner filler rods has a different diameter.

12. The method according to claim 1, wherein said plurality of inner filler rods comprises primary inner filler rods and secondary inner filler rods, said primary inner filler rods having a diameter substantially equal to a diameter of said at least one stress-applying part, said secondary inner filler rods having a diameter smaller than a diameter of said primary inner filler rods and are arranged in gaps between said core rod, said at least one stress-applying part and said primary inner filler rods.

13. The method according to claim 1, wherein said plurality of inner filler rods has substantially a same coefficient of thermal expansion as said cladding of said core rod.

14. The method according to claim 1, wherein said plurality of outer filler rods has substantially a same refractive index as said over-cladding tube.

15. The method according to claim 1, wherein said plurality of outer filler rods has substantially a same coefficient of thermal expansion as said over-cladding tube.

16. A method for manufacturing a polarization-maintaining optical fiber, said method comprising:
(a) making a fiber preform by providing in an over-cladding tube:
(i) a core rod comprising an inner core and a cladding surrounding said inner core, said cladding comprising at least one cladding layer surrounding said inner core;
(ii) at least one stress-applying part disposed adjacent to said core rod along an outer periphery of said cladding thereof, said stress-applying part comprising a material having a coefficient of thermal expansion different from a coefficient of thermal expansion of said cladding of said core rod;
(iii) a plurality of inner filler rods arranged adjacent to said core rod along said outer periphery of said cladding at positions where said at least one stress-applying part is not disposed, said plurality of inner filler rods comprising primary inner filler rods and secondary inner filler rods wherein said secondary inner filler rods have a diameter smaller than a diameter of said primary inner filler rods and are arranged in gaps between said core rod, said at least one stress-applying part and said primary inner filler rods, said inner filler rods comprising material having a coefficient of thermal expansion different from that of said at least one stress-applying part; and
(b) drawing said fiber preform to obtain said optical fiber.

17. The method according to claim 16, wherein the overcladding tube is made of silica glass.

18. The method according to claim 16, wherein said inner core comprises doped silica glass.

19. The method according to claim 16, wherein said at least one cladding layer comprises doped silica glass.

20. The method according to claim 16, wherein said at least one cladding layer has a refractive index lower than a refractive index of said inner core.

21. The method according to claim 16, wherein said cladding comprises two or more cladding layers surrounding said inner core.

22. The method according to claim 16, wherein each of said at least one stress applying part is disposed at discrete intervals along the outer periphery of said cladding of said core rod.

23. The method according to claim 16, wherein two or more of said at least one stress applying part are disposed symmetrically, with respect to an axis of said core rod, along the outer periphery of said cladding of said core rod.

24. The method according to claim 16, wherein two of said at least one stress applying part are diametrically opposed along the outer periphery of said cladding of said core rod.

25. The method according to claim 16, wherein said primary inner filler rods have a diameter substantially equal to a diameter of said at least one stress-applying part.

26. The method according to claim 16, wherein said primary inner filler rods have different diameters for space-filling arrangement about said core rod.

27. The method according to claim 16, wherein said primary inner filler rods have substantially a same refractive index as said secondary inner filler rods.

28. The method according to claim 16, wherein said primary inner filler rods have substantially a same coefficient of thermal expansion as said secondary inner filler rods.

29. The method according to claim 16, wherein said plurality of inner filler rods has substantially a same coefficient of thermal expansion as said cladding of said core rod.

30. The method according to claim 16, wherein said making a fiber preform comprises providing in the over-cladding tube a plurality of outer filler rods arranged adjacent said over-cladding tube between said over-cladding tube and said inner filler rods, said at least one stress-applying part and said core rod, said outer filler rods consisting of a same material as said over-cladding tube.

31. The method according to claim 30, wherein said plurality of outer filler rods has substantially a same refractive index as said over-cladding tube.

32. The method according to claim 30, wherein said plurality of outer filler rods has substantially a same coefficient of thermal expansion as said over-cladding tube.

33. A polarization-maintaining optical fiber obtained according to the method of claim 1.

34. A polarization-maintaining optical fiber obtained according to the method of claim 16.

35. A fiber preform for making a polarization-maintaining optical fiber, said fiber preform comprising:
an over-cladding tube;
a core rod comprising an inner core and a cladding surrounding said inner core, said cladding comprising at least one cladding layer surrounding said inner core;
at least one stress-applying part disposed adjacent to said core rod along an outer periphery of said cladding thereof, said stress-applying part comprising material having a coefficient of thermal expansion different from a coefficient of thermal expansion of said cladding of said core rod;
a plurality of inner filler rods arranged adjacent to said core rod along said outer periphery of said cladding at positions where said at least one stress-applying part is not disposed, said inner filler rods comprising material having a coefficient of thermal expansion different from that of said at least one stress-applying part; and
wherein said core rod, said stress-applying part and said inner filler rods are thus arranged within said over-cladding tube.

36. The fiber preform according to claim 35, comprising a plurality of outer filler rods arranged within said over-cladding tube, adjacent said over-cladding tube, between said over-cladding tube and said inner filler rods, said at least one stress-applying part and said core rod, said outer filler rods consisting of a same material as said over-cladding tube.

37. The fiber preform according to claim 35, wherein said plurality of inner filler rods comprises a plurality of primary inner filler rods and a plurality of secondary inner filler rods, said secondary inner filler rods having a diameter smaller than a diameter of said primary inner filler rods and being arranged in gaps between said core rod, said at least one stress-applying part and said primary inner filler rods.

38. The fiber preform according to claim 35, wherein at least one of said inner filler rods has a different diameter.

39. The fiber preform according to claim 35, wherein said at least one stress applying part comprises a doped silica core and an undoped silica cladding layer surrounding said doped silica core.
